(19) United States
(12) Patent Application Publication
(10) Pub. No.: US 2002/0110245 A1
(43) Pub. Date: Aug. 15, 2002

(54) Method and system for synchronizing security keys in a point-to-multipoint passive optical network

(76) Inventor: Dumitru Gruia, San Ramon, CA (US)

Correspondence Address: Mark A. Wilson, Wilson & Ham, PMB: 348, 2530 Berryessa Road, San Jose, CA, 95132, US

(21) Appl. No.: 09/783,239

(22) Filed: Feb. 13, 2001

(51) Int. Cl. H04L 9/00; H04K 1/00

(52) U.S. Cl. 380/278; 380/274

(57) ABSTRACT

Security key synchronization is maintained between nodes in an optical communications system utilizing out-of-band signaling to indicate that a new key is being used to encrypt subsequent information blocks at the transmitting point and that the new key should be used to decrypt subsequent information blocks at the receiving point. A switch-to-new-key code can be selected from a group of unused codes in an eight bit to ten bit encoding scheme. The switch-to-new-key code can replace an idle code that is used to create sufficient spacing between information blocks. Receipt of the switch-to-new-key code indicates that the new key is being used to encrypt subsequent information blocks at the transmitting point and triggers a switch to the new key for decrypting subsequent information blocks at the receiving point.

### FIELD OF THE INVENTION

The invention relates generally to broadband optical communications networks, and more particularly to encryption messaging in point-to-multipoint passive optical networks.

### BACKGROUND OF THE INVENTION

The explosion of the Internet and the desire to provide multiple communications and entertainment services to end users have created a need for a broadband network architecture that improves access to end users. One broadband network architecture that improves access to end users is a point-to-multipoint passive optical network (PON). A point-to-multipoint PON is an optical access network architecture that facilitates broadband communications between an optical line terminal (OLT) and multiple remote optical network units (ONUs) over a purely passive optical distribution network. A point-to-multipoint PON utilizes passive fiber optic splitters and couplers to passively distribute optical signals between the OLT and the remote ONUs.

FIGS. 1A and 1B represent the downstream and upstream flow of network traffic between an OLT 102 and three ONUs 104 in a point-to-multipoint PON. Although only three ONUs are depicted, more than three ONUs may be included in a point-to-multipoint PON. Referring to FIG. 1A, downstream traffic containing ONU-specific information blocks is transmitted from the OLT. The downstream traffic is optically split by a passive optical splitter 112 into three separate signals that each carries all of the ONU-specific information blocks. Because all of the ONU-specific information blocks are transmitted to each ONU, it is possible for each ONU to read information blocks that are intended for the other ONUs. In order to prevent ONU-specific information blocks from being read by the wrong ONUs, the information blocks intended for each ONU are encrypted and decrypted with encryption/decryption keys that are specific to each ONU. For example, information blocks intended for ONU-1 are encrypted and decrypted with a key that is specific to ONU-1, information blocks intended for ONU-2 are encrypted and decrypted with a key that is specific to ONU-2, and information blocks intended for ONU-3 are encrypted and decrypted with a key that is specific to ONU-3. Although ONU-1 receives encrypted information blocks 1, 2, and 3, it can only decrypt information block 1 with its ONU-specific key. Likewise, ONU-2 can only decrypt information block 2 and ONU-3 can only decrypt information block 3.

Although encrypting and decrypting downstream information blocks with ONU-specific keys works well to create secure downstream connections between the OLT and each ONU, the longer the same key is used to encrypt and decrypt a stream of information blocks, the easier it is for an intruder to figure out the key and decrypt the encrypted information blocks. One technique for improving a secure downstream connection between an OLT and an ONU involves continuously changing the key used between the OLT and the ONU for encryption and decryption. While continuously changing the key used between an OLT and an ONU improves security, the OLT and the ONU must be continuously synchronized so that they are always using the same key to encrypt and decrypt the same information blocks. If the OLT and the ONUs are not using the same keys to encrypt and decrypt the same information blocks, then the ONU will not be able to decrypt the encrypted downstream information blocks.

In an ATM based point-to-multipoint PON as described in the Full Service Access Network (FSAN) specification 983.1 developed through the International Telecommunications Union (ITU), security messages are exchanged between the OLT and the ONUs in 53 byte ATM cells that are dedicated to carrying operations and maintenance (OAM) information (OAM cells). According to the FSAN specifications and as depicted in FIG. 2, a key request 208 is sent in an OAM cell from the OLT to an ONU. In response to the key request, the ONU sends a new key 210 to the OLT in another OAM cell. Once the key has been sent to the OLT, the OLT sends a key synchronization signal 212 (in an OAM cell), which causes the ONU to switch to the new key for decrypting subsequent downstream cells. The ONU sends an acknowledge signal 214 to the OLT in an OAM cell to acknowledge that the key switch has been made. The process of passing a key and synchronizing the key switch is repeated for each ONU that is connected to the OLT.

Although the security messaging technique specified in the FSAN specification works well, the security messaging transmissions consume bandwidth that could be used for other data transmissions. While the amount of bandwidth consumed by security messaging may be small for a single exchange between an OLT and an ONU, the amount of bandwidth consumed by security messaging increases directly with the number of ONUs in the point-to-multipoint PON and with the rate of key changing.

In view of the bandwidth consumed by security messaging, what is needed is a security messaging system that consumes less bandwidth.

### SUMMARY OF THE INVENTION

A method and system for maintaining security key synchronization between nodes in a communications system involves utilizing out-of-band signaling to indicate that a new key is being used to encrypt subsequent information blocks at the transmitting point and that the new key should be used to decrypt subsequent information blocks at the receiving point. In an embodiment, a switch-to-new-key code is selected from a group of unused codes in an eight bit to ten bit encoding scheme. The switch-to-new-key code replaces an idle code that is used to create sufficient spacing between information blocks. Receipt of the switch-to-new-key code indicates that the new key is being used to encrypt subsequent information blocks at the transmitting point and triggers a switch to the new key for decrypting subsequent information blocks at the receiving point.

A method for maintaining synchronization between a key used by a first node to encrypt information and a key used by a second node to decrypt information includes distributing a new key between a first node and a second node, signaling, to one of the first and second nodes, a switch to the new key with a switch-to-new-key code that is not part of the header or the payload of any of the information blocks that are being transmitted between the first and second nodes.

In an embodiment of the method, the first node is an optical line terminal (OLT) of a point-to-multipoint optical communications network and the second node is one of multiple optical network units (ONUs) in the point-to-multipoint optical communications network. A further embodiment of the method includes a step of broadcasting the switch-to-new-key code to all of the multiple ONUs. A further embodiment of the method includes a step of switching to new keys at the ONUs in response to the broadcast of the switch-to-new-key code. In an embodiment, information is formatted according to the IEEE 802.3 protocol. In an embodiment, an unused ten bit code in an eight bit to ten bit encoding scheme is used to generate the switch-to-new-key code. In an embodiment, an idle code between two packets is replaced with the switch-to-new-key code.

A system for maintaining synchronization between a key used by a first node to encrypt information and a key used by a second node to decrypt information includes an OLT and a group of ONUs. The OLT includes an encryption controller and a key synchronization unit. The encryption controller encrypts information within information blocks using ONU-specific keys. The key synchronization unit generates a switch-to-new-key code that is not part of a header or a payload of any information blocks that are transmitted from the OLT to the group of ONUs and causes the OLT encryption controller to use new ONU-specific keys to encrypt information within information blocks that are transmitted after the switch-to-new-key code is transmitted to the group of ONUs. Each of the ONUs includes a key generator, an ONU encryption controller, and a key synchronization unit. The key generator generates a new ONU-specific key that is transmitted to the OLT. The ONU encryption controller decrypts information within information blocks using an ONU-specific key and the key synchronization unit identifies the switch-to-new-code that is transmitted from the OLT and causes the ONU encryption controller to use the new ONU-specific key to decrypt information within the information blocks after the switch-to-new-key code is received from the OLT.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A depicts the downstream flow of traffic from an OLT to multiple ONUs in a point-to-multipoint PON.

FIG. 1B depicts the upstream flow of traffic from multiple ONUs to an OLT in a point-to-multipoint PON.

FIG. 2 depicts the security messaging protocol that is defined by the FSAN specification in accordance with the prior art.

FIG. 3 depicts a point-to-multipoint PON with a tree topology.

FIG. 4 depicts functional blocks of an OLT that is used to carry out security messaging, in accordance with an embodiment of the invention.

FIG. 5 depicts functional blocks of an ONU that is used to carry out security messaging, in accordance with an embodiment of the invention.

FIG. 6 depicts a security messaging technique that utilizes out-of-band signaling to maintain synchronization between keys used to encrypt and decrypt information in accordance with an embodiment of the invention.

FIG. 7 depicts six consecutive idle codes that separate packets as required by the 1000BASE-X specification of the IEEE 802.3 protocol.

FIG. 8 depicts a switch-to-new-key code that has been inserted between two packets in the place of an idle code in accordance with an embodiment of the invention.

FIG. 9 depicts multiple switch-to-new-key codes that have been inserted between two packets in the place of idle codes in accordance with an embodiment of the invention.

FIG. 10 depicts switch-to-new-key codes that have been inserted in the place of idle codes in at least two different idle spaces between packets in accordance with an embodiment of the invention.

FIG. 11 depicts a switch-to-new-key code that is inserted at the beginning of an upstream time slot in accordance with an embodiment of the invention.

FIGS. 12A-12C depict an embodiment of an encryption messaging technique for two-way encryption that utilizes out-of-band signaling for key synchronization.

FIG. 13 is a process flow diagram of a method for maintaining security key synchronization in accordance with an embodiment of the invention.

FIG. 14 is a process flow diagram of a method for maintaining security key synchronization in accordance with another embodiment of the invention.

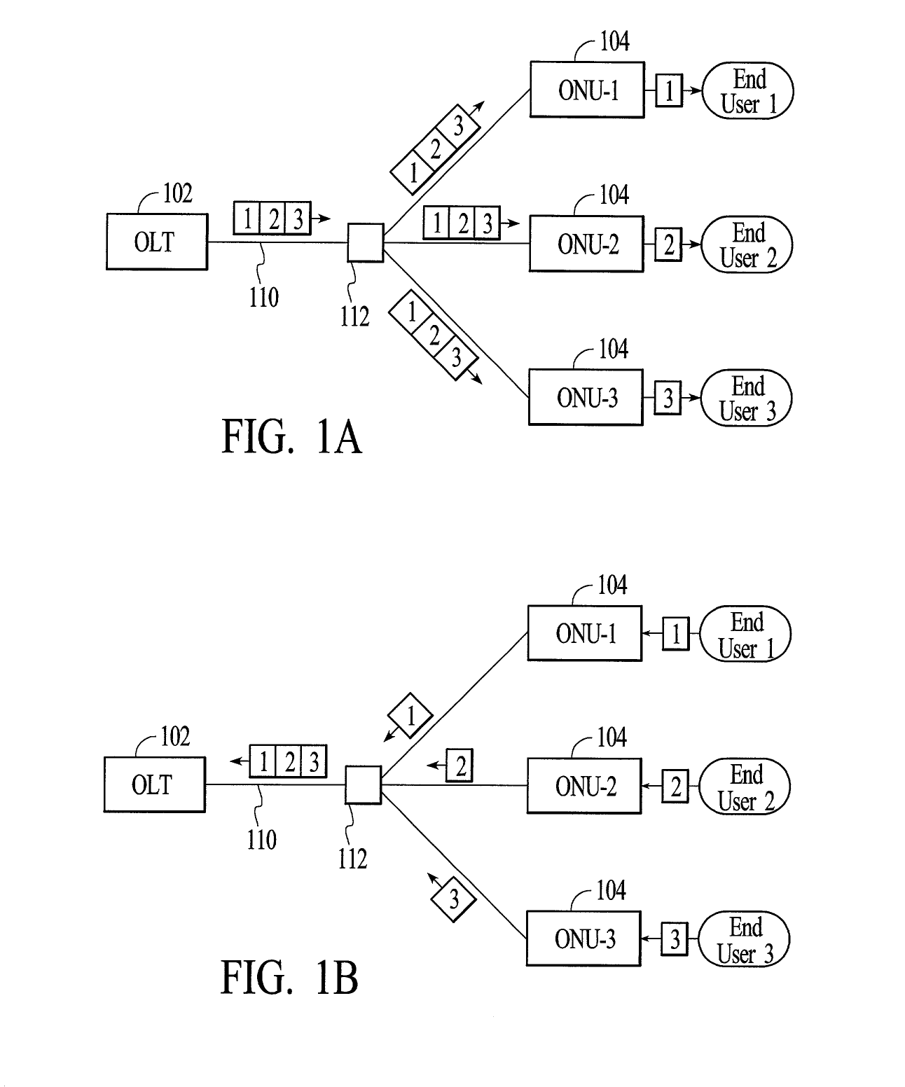

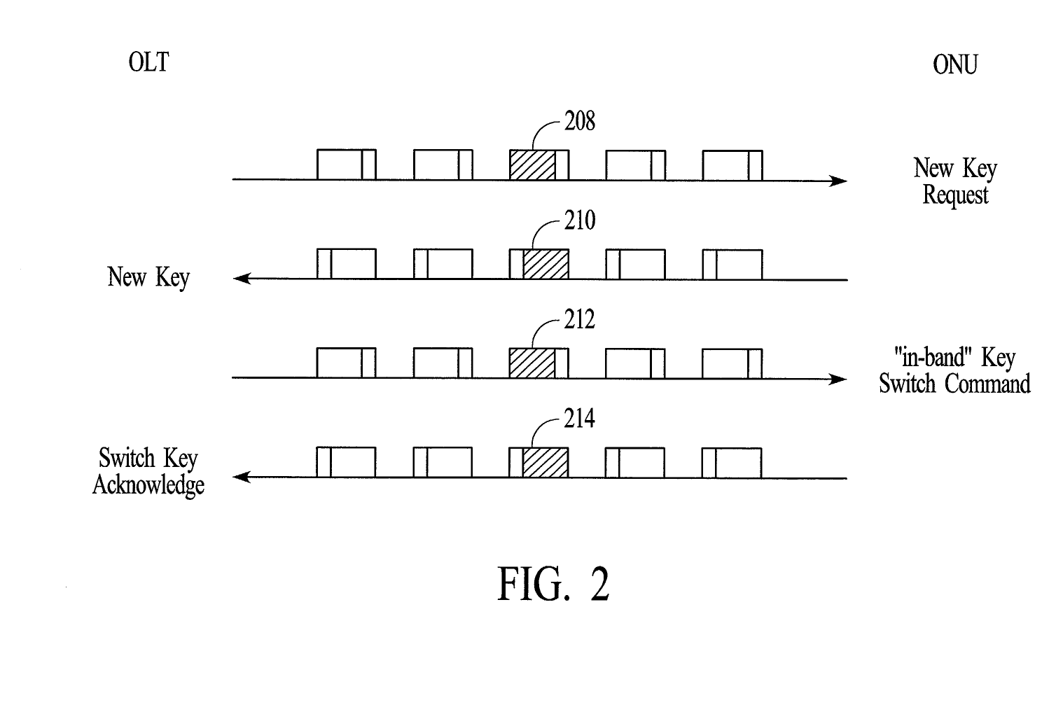

### DETAILED DESCRIPTION OF THE INVENTION

A method and system for maintaining security key synchronization between nodes in a communications system involves utilizing out-of-band signaling to indicate that a new key is being used to encrypt subsequent information blocks at the transmitting point and that the new key should be used to decrypt subsequent information blocks at the receiving point. In an embodiment, a switch-to-new-key code is selected from a group of unused codes in an eight bit to ten bit encoding scheme. The switch-to-new-key code replaces an idle code that is used to create sufficient spacing between information blocks.

Receipt of the switch-to-new-key code indicates that the new key is being used to encrypt subsequent information blocks at the transmitting point and triggers a switch to the new key for decrypting subsequent information blocks at the receiving point.

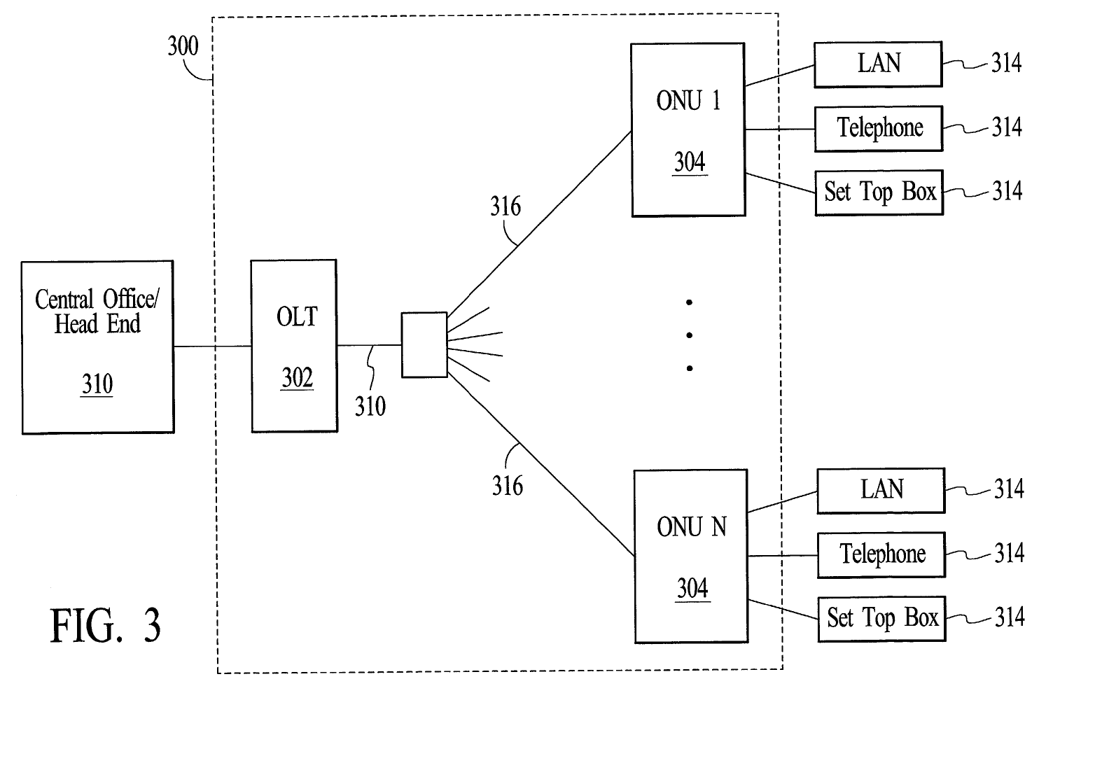

FIG. 3 depicts an example point-to-multipoint PON 300. The point-to-multipoint PON includes an OLT 302 and multiple ONUs 304 that are connected by a passive optical distribution network. In an embodiment, the OLT is connected to a service station 310 such as a Central Office and/or a head-end station. Services provided at the service station may include data network access, voice network access, and/or video network access. Example connection protocols utilized between the service station and the OLT may include OC-x, Ethernet, E1/T1, DS3, and broadband video. In an embodiment, the ONUs are connected to an end user system or systems 214, which may include a local area network, personal computers, a PBX, telephones, set-top boxes, and/or televisions. Example connection protocols utilized between the end user systems and the ONUs may include 10/100 Mb/s Ethernet, T1, and plain old telephone service (POTS).

The passive optical distribution network shown in FIG. 3 has a tree topology that includes a common optical fiber 310 (trunk fiber) and multiple different fibers 316 that are connected by a passive optical splitter/coupler 312 to the trunk fiber. An optical signal transmitted in the downstream direction (from the OLT 302 to the ONUs 304) is optically split into multiple ONU-specific optical signals that all carry the same information. Because of the broadcast nature of downstream transmissions in a point-to-multipoint PON, all of the ONUs always receive the same information from the OLT. Although all of the ONUs receive the same information from the OLT, the actual receipt time of the signals may vary slightly from ONU to ONU because of differences in travel distances.

Optical signals transmitted in the upstream direction (from the ONUs to the OLT) are optically coupled into the trunk fiber that is connected between the coupler and the OLT. The coupler is a directional coupler that passes upstream transmissions from the ONUs to the OLT and does not allow upstream transmissions to be received by any other ONUs. Time division multiplexing is utilized in the upstream direction to prevent collisions of upstream transmissions from two or more ONUs.

In the embodiment of FIG. 3, an optical signal in the downstream direction is transmitted at a different wavelength (or frequency) than an optical signal in the upstream direction. In an embodiment, downstream traffic is transmitted in the 1550 nm wavelength band and upstream traffic is transmitted in the 1310 nm wavelength band. Utilizing different wavelengths in the upstream and downstream directions allows a single optical fiber to simultaneously carry downstream and upstream traffic without interfering collisions. In an alternative embodiment, separate downstream and upstream fibers may be utilized for the passive optical distribution network. In addition, wavelength division multiplexing (WDM), multi-state modulation beyond the binary state, or other techniques may be used in the downstream and/or upstream directions to increase transmission bandwidth.

Although the passive optical distribution network of FIG. 3 has a tree topology, alternative network topologies are possible. Alternative network topologies include a bus topology and a ring topology. In addition, although the distribution network of FIG. 3 depicts only single fiber connections between network components, redundant fibers may be added between network components to provide fault protection.

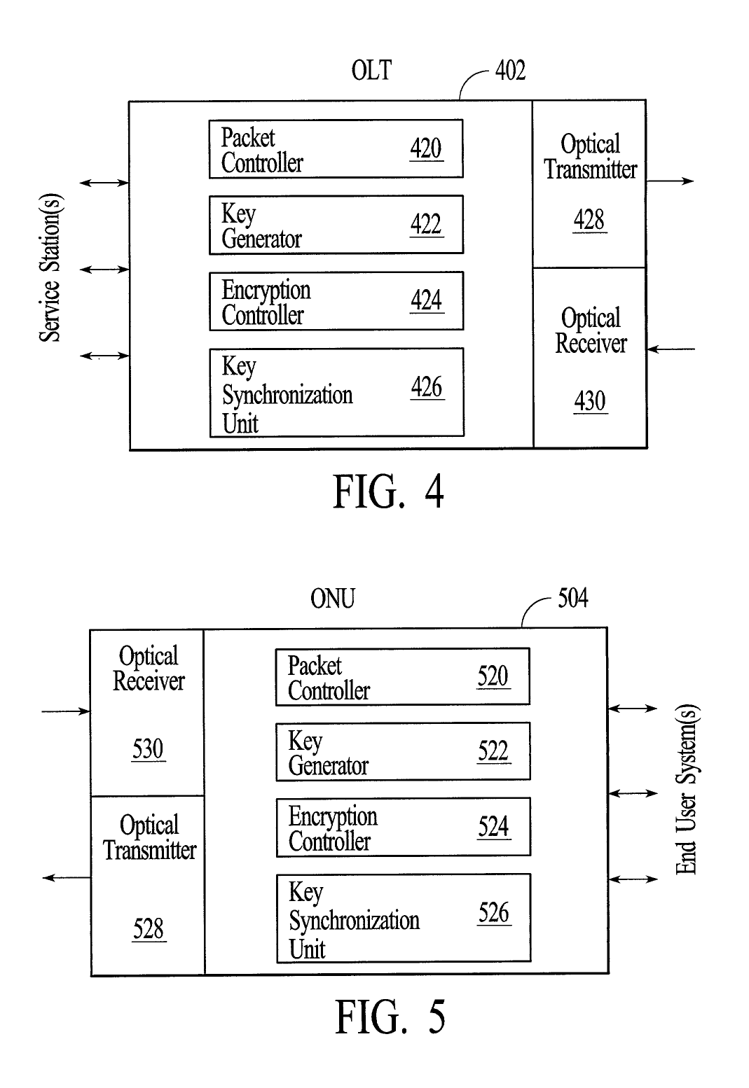

FIG. 4 is an expanded view of an example OLT 402 in the point-to-multipoint PON 300 of FIG. 3. Functional units included within the OLT that are used to carry out security messaging are a packet controller 420, a key generator 422, an encryption controller 424, a key synchronization unit 426, an optical transmitter 428, and an optical receiver 430. The OLT may also include other well known functional units that are not depicted. The packet controller receives downstream digital data from a service station and formats the downstream digital data into information blocks referred to as packets. The packet controller may be embodied in hardware and/or software and is sometimes referred to as the media access control (MAC) unit. In an embodiment, each packet includes a fixed-length header at the front of the packet, a variable-length payload after the header, and a fixed-length error detection field (such as a frame check sequence (FCS) field) at the end of the packet. In an embodiment, the downstream packets are formatted according to the IEEE 802.3 standard (commonly referred to as Ethernet) or any of the related IEEE 802.3x sub-standards. In an embodiment, the downstream packets are transmitted over optical fiber at a rate of 1 gigabit per second (Gb/s) as defined by IEEE 802.3z (commonly referred to as gigabit Ethernet) using the 1000BASE-X specification. Lower or higher transmission rates may be utilized in other embodiments.

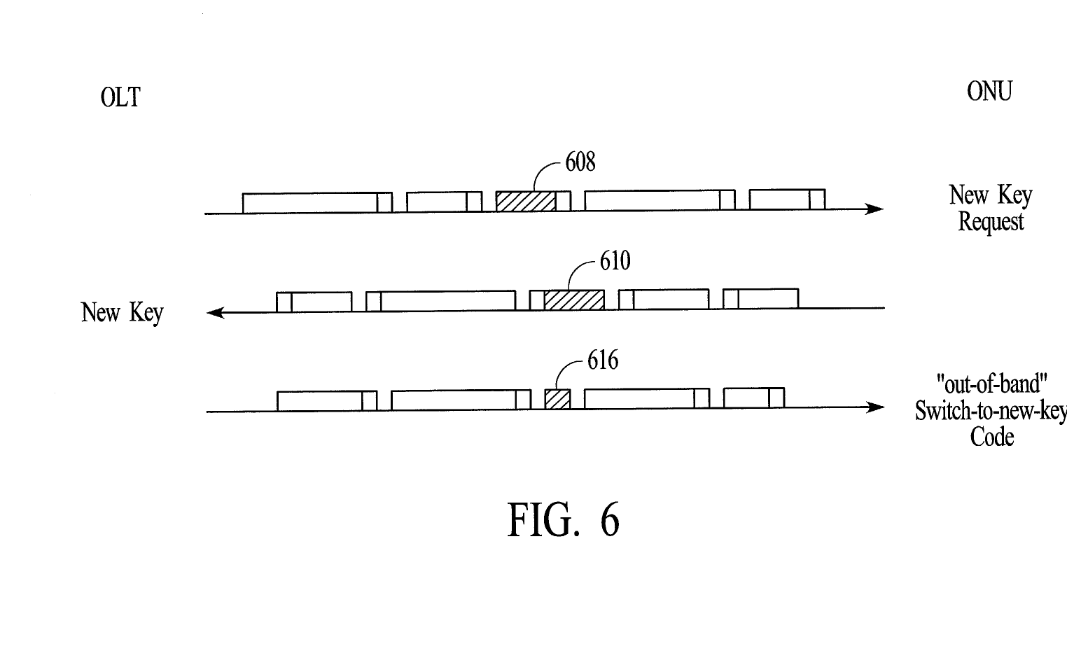

The key generator 422 is a functional unit that generates new keys for encryption and decryption. Typically, the key generator uses a random number generator to generate new keys. The encryption controller 424 is a functional unit that encrypts and decrypts the information within packets. In an embodiment, only the payload portions of packets are encrypted and decrypted although in other embodiments entire packets are encrypted and decrypted. When entire packets are encrypted, all of the received packets are decrypted and checked to see if they are valid packets that are intended for the respective ONU. In a system that implements only downstream encryption, the encryption controller of the OLT only performs encryption. In a system that implements downstream and upstream encryption, the encryption controller of the OLT performs both downstream encryption and upstream decryption. The key synchronization 426 unit is a functional unit that maintains synchronization between the keys that are used to encrypt information within packets and the keys that are used to decrypt information within packets. Example embodiments of the key synchronization process are described below with reference to FIGS. 6-13.

The optical transmitter 428 and the optical receiver 430 provide the interface between optical and electrical signals. Optical transmitters and receivers are well known in the field of point-to-multipoint PONs and are not described in further detail. FIG. 5 is an expanded view of an example ONU 504 in the point-to-multipoint PON 300 of FIG. 3. Functional units included within the ONUs that are used to carry out security messaging are a packet controller 520, a key generator 522, an encryption controller 524, a key synchronization unit 526, an optical transmitter 528, and an optical receiver 530. The ONUs may also include other well known functional units that are not depicted. The packet controller receives upstream digital data from end user systems and formats the upstream digital data into information blocks referred to as packets, with each packet including a header, a payload, and an error detection field as described above with reference to the downstream traffic. The packet controller is embodied in hardware and/or software and is sometimes referred to as the MAC unit. As with the downstream traffic, in an embodiment, the upstream packets are formatted according to the IEEE 802.3 standard and transmitted at a rate of 1 Gb/s. Although ONU refers to optical network unit, ONU may also refer to a functionally equivalent optical node unit.

The key generator 522 is a functional unit that generates new ONU-specific keys for encryption and decryption. Typically, the key generator uses a random number generator to generate new ONU-specific keys. The encryption controller 524 is a functional unit that encrypts and decrypts the information within packets. In an embodiment, only the payload portions of packets are encrypted and decrypted. In a system that implements only downstream encryption, the encryption controller of the ONU decrypts encrypted packets. In a system that implements downstream and upstream encryption, the encryption controller performs both downstream decryption and upstream encryption. The key synchronization 526 unit is a functional unit that maintains synchronization between the keys that are used to encrypt information within packets and the keys that are used to decrypt information within packets. Example embodiments of the key synchronization process are described below with reference to FIGS. 6-13.

The optical transmitter 528 and the optical receiver 530 provide the interface between optical and electrical signals. Optical transmitters and receivers are well known in the field of point-to-multipoint PONs and are not described in further detail.

FIG. 6 depicts an embodiment of a method for security messaging in a point-to-multipoint PON that utilizes “out-of-band” signaling to maintain synchronization between keys used to encrypt and decrypt information. In the embodiment of FIG. 6, a new key request is generated by the encryption controller of the OLT for each ONU and the new key requests are transmitted from the OLT to the ONUs. In an embodiment, the new key requests are carried in packets that are addressed to specific ONUs. As shown in FIG. 6, a new key request 608 is transmitted from the OLT in an Ethernet packet having a header and a payload. In response to the ONU-specific key requests, the key generator of each individual ONU generates a new ONU-specific key 610 and the new ONU-specific key is transmitted upstream to the OLT. In an embodiment, the new ONU-specific keys are transmitted upstream in the payload of packets. Referring to FIG. 3, a new ONU-specific key is transmitted from each of the ONUs in the point-to-multipoint PON.

Once new ONU-specific keys have been passed from all of the ONUs to the OLT, the key synchronization unit of the OLT initiates a system-wide switch to the new ONU-specific keys. The key synchronization unit of the OLT initiates the switch to the new ONU-specific keys by generating and transmitting a switch-to-new-key code that is not part of any of the packets that are being transmitted to the ONUs. That is, the switch-to-new-key code is a special code that is transmitted between packets and that does not conform to a packet format. Referring to FIG. 6, an example switch to-new-key code 616 is represented as a signal that is transmitted between two packets. Embodiments of the switch-to-new-key code are described below in more detail.

Once the switch-to-new-key code is transmitted from the OLT, the encryption controller of the OLT encrypts subsequently transmitted ONU-specific packets using the new ONU-specific keys that were previously supplied to the OLT. Once the switch-to-new-key code is received by the ONUs and identified by the respective key synchronization unit, the key synchronization unit causes the encryption controller of the ONU to decrypt subsequent packets with the new ONU-specific key. The process of switching keys is continuously repeated to prevent the same key from being used for an extended period of time.

As described above, an embodiment of the system and method utilizes gigabit Ethernet over optical fiber. The IEEE 802.3 specification for gigabit Ethernet over single mode and multimode mode optical fiber is defined in the 1000BASE-X specification. The 1000BASE-X specification uses an eight bit-to-ten bit (8B/10B) encoding scheme in which eight bits of data (one byte) are encoded into ten bit codes. Among other reasons, the 8B/10B encoding is implemented to ensure sufficient signal transitions for clock recovery at the receiver. Because eight bits can represent 256 different data values while ten bits can represent 1,024 different data values, there are more ten bit codes available than there are values to encode. According to the 1000BASE-X specification, the available code space is divided into two groups of codes, the “D” group of codes and the “K” group of codes. The “D” group of codes are used to encode data bytes and the “K” group of codes (also referred to as the special codes) are used to encode special control characters. The special codes are interpreted at the physical layer and provide for “out-of-band” signaling, that is signaling that is not part of a packet. In order to ensure DC-balance in a bitstream, each byte value and each special code is represented by two different ten bit codes. Although there are two different ten bit codes designated for each byte value and for each special code, there are still many codes available that exhibit sufficient signal transitions and that have not been designated for use as a byte value or a special code by IEEE 802.3.

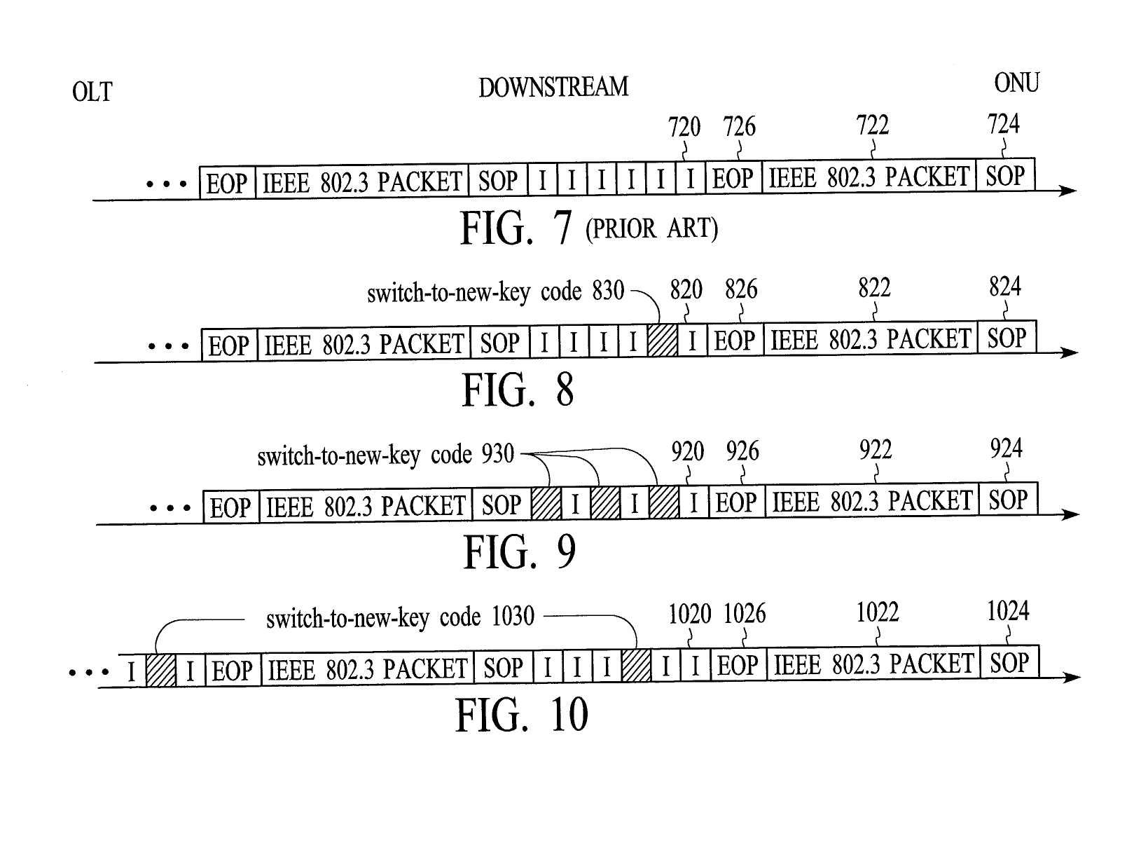

In addition to the 8B/10 encoding, the 1000BASE-X specification requires that each packet in a transmission be separated by a minimum amount of time (96 us) in order to allow receivers enough time to recover between packets and to prepare to receive the next packet. Referring to FIG. 7, the minimum amount of spacing between packets is created using a series of special codes referred to as idle codes 720. According to the 1000BASE-X specification, an idle code can be an idle 1 code (I1) or an idle 2 code (I2). The I1 and I2 codes each include two code words (/K28.5/D5.6/ and /K28.5/D16.2/, respectively) and the minimum spacing between packets of 96 us is created by inserting at least six consecutive idle codes between packets. In FIG. 7, each packet 722 is bordered by start-of packet (SOP) and end-of-packet (EOP) control signals 724 and 726. The inner portion of the packet is defined as an “in-band” signal and the SOP, EOP, and idle codes are defined as “out-of-band” signals. Both the in-band and out-of-band signals are transmitted using the same carrier wavelength.

In an embodiment of the method and system for maintaining key synchronization, at least one of the unused ten bit code words is used to generate the switch-to-new-key code. In an embodiment, the switch-to-new-key code includes two ten bit code words so that the switch-to-new-key code has the same bit length as the idle codes. The switch-to-new-key code is inserted in the place of one of the six idle codes to initiate key switching with an out-of-band signal. The switch-to-new-key code indicates that subsequent packets are encrypted using the new key and therefore should be decrypted using the new key. FIG. 8 depicts a switch-to-new-key code 830 that has been inserted between two packets in the place of an idle code. As described above, the purpose of the idle codes is to provide a minimum amount of spacing between packets. By replacing an idle code with a switch-to-new-key code of equal bit length, the minimum spacing between packets is maintained and a key synchronization signal can be transmitted without consuming additional bandwidth.

Referring back to FIGS. 3 and 6, because of the broadcast nature of downstream transmissions in a point-to-multipoint PON, all of the ONUs receive the same switch-to-new-key code and the switch-to-new-key code triggers a nearly simultaneously system-wide switch to the new ONU-specific keys. Although the system-wide switch is not exactly simultaneous because of differences in transmission time, the system-wide switch is initiated by the same switch-to-new-key code. In contrast, FSAN specifies sending a unique key synchronization signal to each ONU within ONU-specific cells to trigger the switching of keys. That is, a separate cell is sent to each ONU to trigger the key switch at the respective ONU. Because a separate cell is sent for each ONU, the FSAN specified system-wide key switch happens over a relatively long period of time. In addition, the use of ONU-specific cells for key synchronization as specified by FSAN consumes bandwidth that could be used to transmit other information.

In an embodiment, the switch-to-new-key code described with reference to FIG. 8 is sent more than one time to ensure that at least one of the codes is correctly received by each of the ONUs. Referring to FIG. 9, multiple idle codes are replaced by the switch-to-new-key code in the gap between two packets to ensure that at least one of the codes is correctly received by each of the ONUs. Referring to FIG. 10, in another embodiment, at least one idle code is replaced in successive gaps between frames to ensure that at least one of the codes is correctly received by each of the ONUs. In another embodiment, a combination of the approaches in FIGS. 9 and 10 is implemented.

In the above described embodiment, the switch-to-new-key code is sent from the OLT after all of the ONUs have generated and sent a new ONU-specific key. In other embodiments, the switch-to-new-key code can be sent from the OLT even if new keys have not been received from all of the ONUs. When an ONU that has not provided a new key receives a switch-to-new-key code, the ONU can either ignore the code or simply perform a “switch” that results in using the same key that is currently being used.

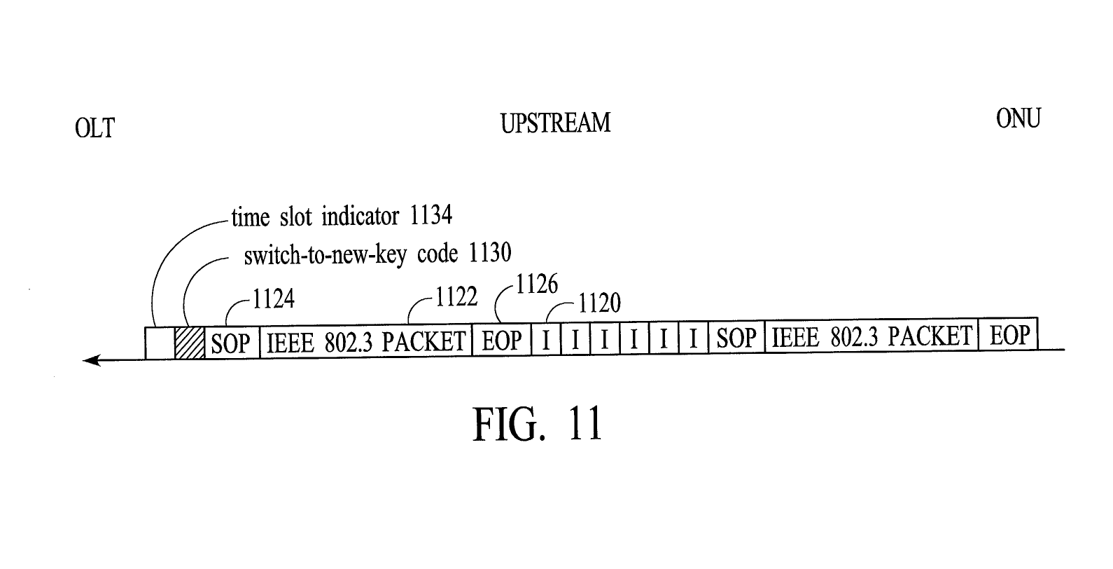

In an embodiment, encrypted signals are transmitted in the upstream direction as well as the downstream direction. To encrypt signals in the upstream direction, a new key (referred to herein as the upstream key) is sent from the OLT to the ONUs. The ONUs indicate that the new key is being used to encrypt subsequent packets with a switch-to-new-key code that is selected from one of the unused codes as described above. In an embodiment, the upstream switch-to-new-key code is the same as the downstream switch-to-new-key code. In an embodiment, ONUs insert the switch-to-new-key code at the beginning of a time slot to indicate that all subsequent packets are encrypted using a new upstream key. FIG. 11 depicts a switch-to-new-key code 1130 that is inserted at the beginning of an upstream time slot. The switch-to-new-key code indicates that subsequent packets in that ONU-specific time slot are encrypted with the new upstream key. Because the OLT knows which upstream time slot is assigned to which ONU, the upstream switch-to-new-key code can be the same for all ONUs. In the embodiment of FIG. 11, the beginning of the upstream time slot is identified by a time slot indicator 1134. In another embodiment, the switch-to-new-key code can replace an idle code between packets within a time slot instead of at the beginning of the time slot.

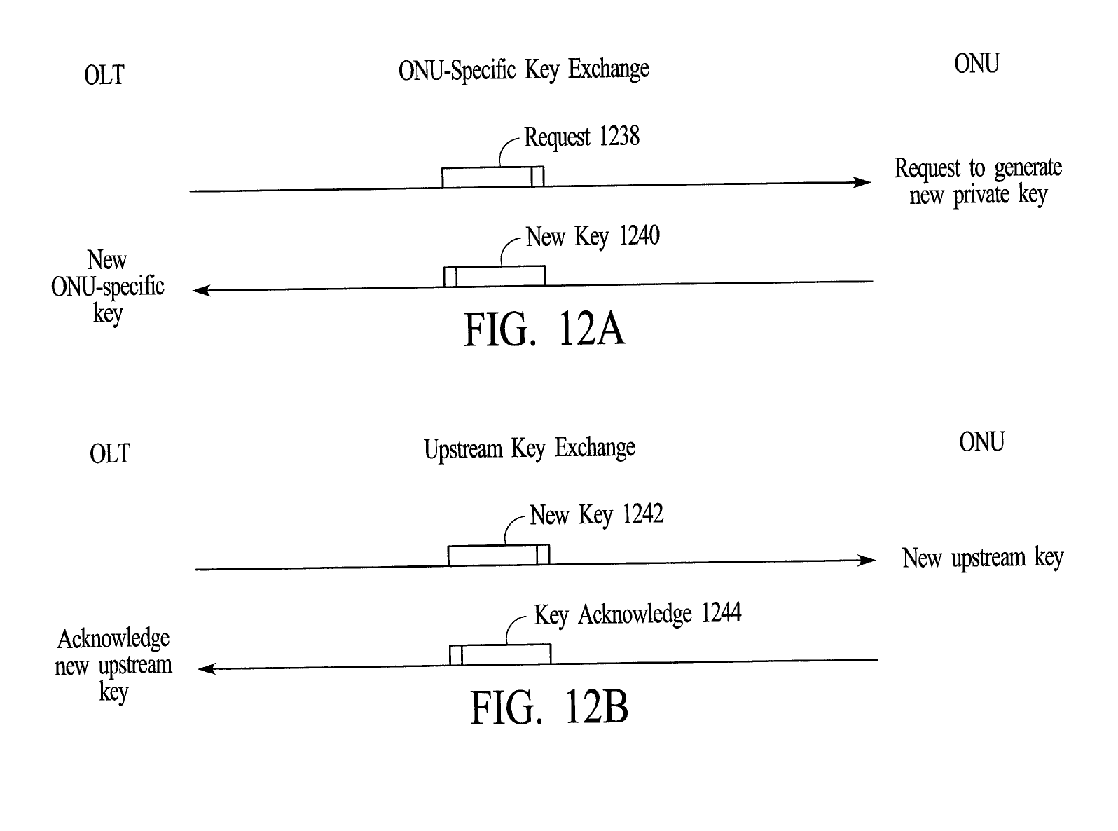

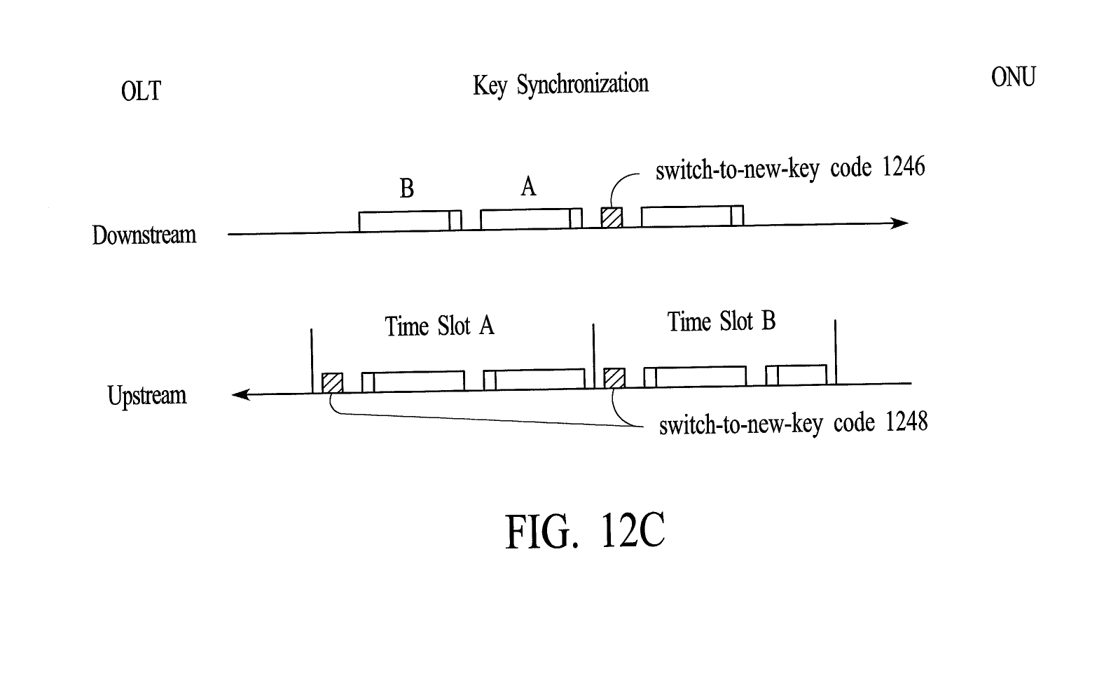

FIGS. 12A-12C depict an embodiment of an encryption messaging technique for two-way encryption that utilizes out-of-band signaling for key synchronization. The technique involves providing new ONU-specific keys to the OLT, providing a new upstream key to the ONUs, and synchronizing the use of the ONU-specific and upstream keys between the OLT and the ONUs. Referring to FIG. 12A, the process of providing new ONU-specific keys to the OLT involves the OLT sending a new key request 1238 to each ONU. The new key requests are specific to each ONU and are sent in packets addressed to the particular ONUs. In response to the new key requests, the ONUs send new ONU-specific keys 1240 to the OLT. Referring to FIG. 12B, the process of providing a new upstream key to the ONUs involves the OLT sending a new upstream key 1242 to all of the ONUs. In one embodiment, multiple upstream keys are sent individually to the ONUs in individually addressed packets and in another embodiment, a single upstream key is sent to the ONUs in a broadcast packet. Once an upstream key is received by an ONU, the ONU sends a key acknowledge signal 1244 to the OLT in an upstream packet. The processes depicted in FIGS. 12A and 12B are continued until the key exchange between the OLT and the ONUs is completed.

FIG. 12C depicts the process of two-way key synchronization using out-of-band signaling as described above. In the downstream direction, a switch-to-new-key code 1246 is placed in idle space between packets using an available ten bit code as described above. All packets sent by the OLT after the switch-to-new-key code are encoded using the new ONU-specific encryption keys. For example, packet A is intended for ONU-1 and is encrypted with a new key that is specific to ONU-1 and packet B is intended for ONU-2 and is encrypted with a key that is specific to ONU-2. In the upstream direction, a switch-to-new-key code 1248 is placed at the beginning of the ONU-specific time slots using an available ten bit code as described above. All packets sent by an ONU after the switch-to-new-key code are encoded using the new upstream key. A switch-to-new-key code is sent from each ONU to signify that the ONU has switched to a new upstream key. That is, all packets sent in time slot A after the time slot A switch-to-new-key code are encrypted using the new upstream key and all packets sent in time slot B after the time slot B switch-to-new-key code are encrypted using the new upstream key. In the embodiment, the upstream switch-to-new-key codes are the same for each ONU and the source of the switch-to-new-key code is identified by the time slot in which the switch-to-new-key code arrives. In an embodiment, the switch-to-new-key code in the downstream direction 1246 triggers the switch-to-new-key code 1248 in the upstream direction.

In another embodiment, a different unused special code is designated to indicate that the upstream key should be used to decrypt the next downstream packet. This code, referred to herein as the use-broadcast-key code allows the OLT to send a single downstream “broadcast” packet that can be decrypted by all of the ONUs. In an embodiment, the broadcast key is the same key that is used for upstream encryption/decryption. The ONUs return to using their ONU-specific keys for decryption after one packet is decrypted. In another embodiment, the use-broadcast-key code triggers the decrypting of a specific number of subsequent packets, where the specific number is greater than one.

The Ethernet specification was developed to create an open environment in which components from different manufacturers can be internetworked together. In order for different components to be compatible, the components must strictly adhere to the IEEE 802.3 specification. Creating manufacturer specific equipment that utilizes non-IEEE 802.3 codes such as the switch-to-new-key code causes the equipment to be incompatible with other Ethernet compatible components. While creating new special codes is unacceptable for Ethernet components that are intended to be internetworked in a open environment, new special codes can be utilized in a system that is closed from end-to-end, such as a point-to-multipoint PON in which the OLT and the ONUs are part of a proprietary system.

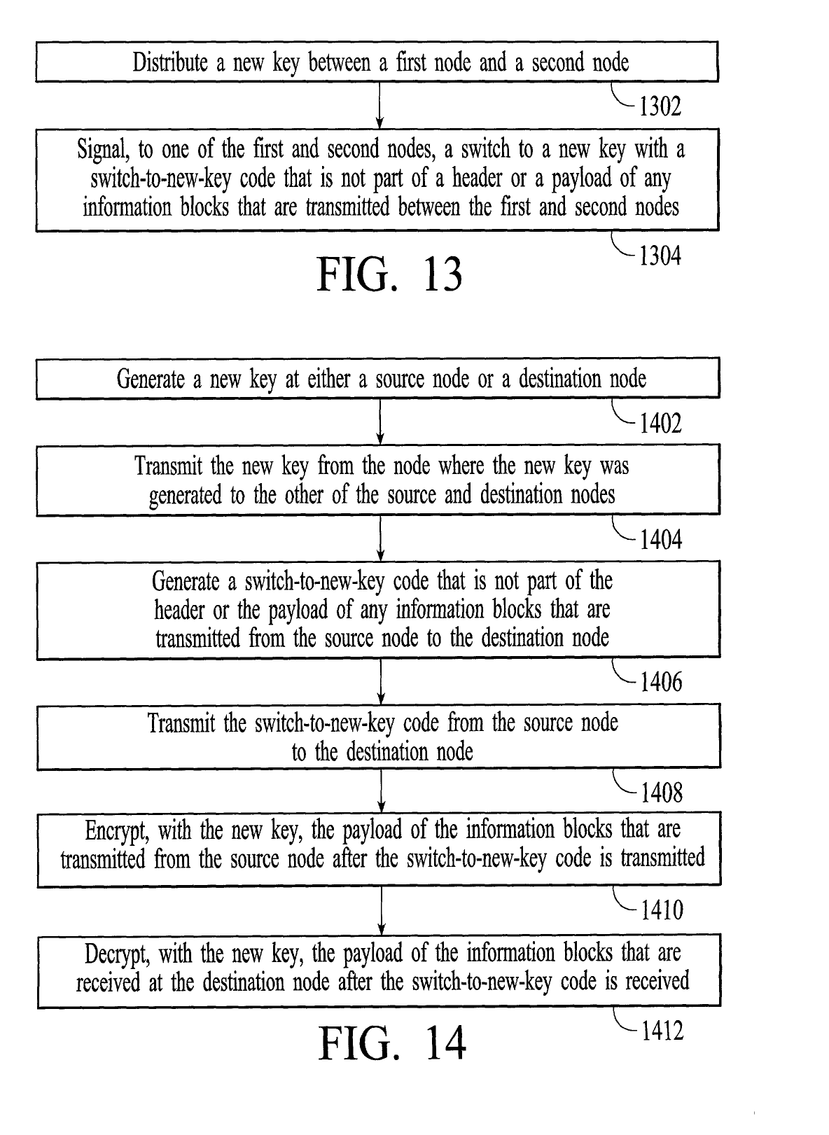

FIG. 13 is a process flow diagram of an embodiment of a method for maintaining security key synchronization. At step 1302, a new key is distributed between a first node and a second node. At step 1304, a switch to a new key is signaled, to one of the first and second nodes, with a switch-to-new-key code that is not part of a header or a payload of any information blocks that are transmitted between the first and second nodes.

FIG. 14 is a process flow diagram of another embodiment of a method for maintaining security key synchronization. At step 1402, a new key is generated at either a source node or a destination node. At step 1404, the new key is transmitted from the node where the new key was generated to the other of the source and destination nodes. At step 1406, a switch-to-new-key code is generated that is not part of the header or the payload of any information blocks that are transmitted from the source node to the destination node. At step 1408, the switch-to-new-key code is transmitted from the source node to the destination node. At step 1410, the payload portions of the information blocks that are transmitted from the source node are encrypted with the new key after the switch-to-new-key code is transmitted. At step 1412, the payload portions of the information blocks that are received at the destination node are decrypted with the new key after the switch-to-new-key code is received.

What is claimed is:

1. A method for maintaining synchronization between a key used by a first node to encrypt information within information blocks that are transmitted via a communications network to a second node and a key used by said second node to decrypt information within information blocks received from said first node, each information block including a header and a payload, said method comprising:
distributing a new key between a first node and a second node; and
signaling, to one of said first and second nodes, a switch to said new key with a switch-to-new-key code that is not part of said header or said payload of any of said information blocks that are being transmitted between said first and second nodes.

2. The method of claim 1 wherein said first node is an optical line terminal (OLT) of a point-to-multipoint optical communications network and wherein said second node is one of multiple optical network units (ONUs) in said point-to-multipoint optical communications network.

3. The method of claim 2 further including a step of broadcasting said switch-to-new-key code to all of said multiple ONUs.

4. The method of claim 3 further including a step of switching to new keys at said ONUs in response to said broadcast of said switch-to-new-key code.

5. The method of claim 4 wherein said information blocks are formatted according to the IEEE 802.3 protocol.

6. The method of claim 5 wherein said step of signaling includes a step of utilizing an unused ten bit code in an eight bit to ten bit encoding scheme to generate said switch-to-new-key code.

7. The method of claim 6 wherein said step of signaling includes a step of replacing an idle code between two information blocks with said switch-to-new-key code.

8. The method of claim 1 wherein said step of signaling includes a step of generating an out-of-band signal as said switch-to-new-key code.

9. The method of claim 8 wherein said step of generating an out-of-band signal includes a step of utilizing an unused ten bit code in an eight bit to ten bit encoding scheme to generate said switch-to-new-key code.

10. The method of claim 1 wherein said step of signaling includes a step of replacing an idle code between two information blocks with said switch-to-new-key code.

11. A method for maintaining synchronization between a key used by a source node to encrypt information within information blocks that are transmitted via a communications network to a destination node and a key used by said destination node to decrypt information within information blocks received from said source node, each information block including a header and a payload, said method comprising:
generating a new key at either said source node or said destination node;
transmitting said new key from the node where said new key was generated to the other of said source and destination nodes;
generating a switch-to-new-key code that is not part of said header or said payload of any information blocks that are transmitted from said source node to said destination node;
transmitting said switch-to-new-key code from said source node to said destination node;
encrypting, with said new key, said payload of said information blocks that are transmitted from said source node after said switch-to-new-key code is transmitted; and
decrypting, with said new key, said payload of said information blocks that are received at said destination node after said switch-to-new-key code is received.

12. The method of claim 11 wherein said source node is an optical line terminal (OLT) of a point-to-multipoint optical communications network and wherein said destination node is one of multiple optical network units (ONUs) in said point-to-multipoint optical communications network.

13. The method of claim 12 further including a step of broadcasting said switch-to-new-key code to all of said multiple ONUs.

14. The method of claim 13 further including a step of switching to new keys at said ONUs in response to said broadcast of said switch-to-new-key code.

15. The method of claim 14 wherein said information blocks are formatted according to the IEEE 802.3 protocol.

16. The method of claim 15 wherein said step of generating a switch-to-new-key code includes a step of utilizing an unused ten bit code in an eight bit to ten bit encoding scheme to generate said switch-to-new-key code.

17. The method of claim 16 wherein said step of generating a switch-to-new-key code includes a step of replacing an idle code between two information blocks with said switch-to-new-key code.

18. The method of claim 11 wherein said step of generating a switch-to-new-key code includes a step of generating an out-of-band signal as said switch-to-new-key code.

19. The method of claim 18 wherein said step of generating an out-of-band signal includes a step of utilizing an unused ten bit code in an eight bit to ten bit encoding scheme to generate said switch-to-new-key code.

20. The method of claim 11 wherein said step of generating a switch-to-new-key code includes a step of replacing an idle code between two information blocks with said switch-to-new-key code.

21. A method for maintaining synchronization between keys used by an optical line terminal (OLT) to encrypt information within information blocks that are transmitted via a point-to-multipoint optical communications network to a plurality of optical network units (ONUs) and keys used by said plurality of ONUs to decrypt information within information blocks received from said OLT, each information block including a header and a payload, said method comprising:
generating new ONU-specific keys at said plurality of ONUs;
transmitting said new ONU-specific keys from said plurality of ONUs to said OLT;
generating, at said OLT, a switch-to-new-key code that is not part of said header or said payload of any information blocks that are transmitted from said OLT to said plurality of ONUs;
transmitting said switch-to-new-key code from said OLT to said plurality of ONUs;
encrypting, with said new ONU-specific keys, said payload of said information blocks that are transmitted from said OLT after said switch-to-new-key code is transmitted; and
decrypting, with said new ONU-specific keys, said payload of said information blocks that are received at said plurality of ONUs after said switch-to-new-key code is received.

22. The method of claim 21 wherein said switch-to-new-key code is received by each of said plurality of ONUs and wherein each of said ONUs switch to said new ONU-specific keys in response to said switch-to-new-key code.

23. The method of claim 21 wherein said switch-to-new-key code is an out-of-band signal.

24. The method of claim 21 wherein said switch-to-new-key code includes an unused ten bit code in an eight bit to ten bit encoding scheme.

25. The method of claim 24 wherein said information blocks are formatted according to the IEEE 802.3 protocol.

26. The method of claim 24 wherein said information blocks are transmitted according to the 1000BASE-X specification of the IEEE 802.3 protocol.

27. The method of claim 21 further including:
transmitting upstream switch-to-new-key codes from said plurality of ONUs to said OLT;
encrypting, with a new upstream key, information blocks that are transmitted from said plurality of ONUs to said OLT after said upstream switch-to-new-key codes are transmitted; and
decrypting, with said new upstream key, said information blocks that are received at said OLT after said upstream switch-to-new-key code is received.

28. The method of claim 27 wherein said upstream switch-to-new-key code is transmitted from said plurality of ONUs in response to receiving said switch-to-new-key code from said OLT.

29. The method of claim 21 further including:
transmitting a use-broadcast-key code from said OLT to said plurality of ONUs;
encrypting, with a broadcast key, a specific number of information blocks after said use-broadcast-key code is transmitted; and
decrypting, with said broadcast key, said specific number of information blocks after said use-broadcast-key code is received.

30. A system for maintaining synchronization between a key used by a first node to encrypt information within information blocks that are transmitted via a communications network to a second node and a key used by said second node to decrypt information within information blocks received from said first node, each information block including a header and a payload, said system comprising:
means for distributing a new key between said first node and said second node; and
means for signaling, to one of said first and second nodes, a switch to said new key with a switch-to-new-key code that is not part of said header or said payload of any of said information blocks that are transmitted between said first and second nodes.

31. The system of claim 30 wherein said first node is an optical line terminal (OLT) of a point-to-multipoint optical communications network and wherein said second node is one of multiple optical network units (ONUs) in said point-to-multipoint optical communications network.

32. The system of claim 31 wherein said switch-to-new-key code is transmitted to all of said multiple ONUs simultaneously.

33. The system of claim 32 wherein said OLT includes a key synchronization unit for generating said switch-to-new-key code and wherein said ONUs include a key synchronization unit for identifying said switch-to-new-key code and for triggering a switch to said new key for decryption of said information after said switch-to-new-key code is identified.

34. The system of claim 31 wherein said OLT and said ONUs include packet controllers for generating information blocks that are formatted according to the IEEE 802.3 protocol.

35. The system of claim 30 wherein said switch-to-new-key code replaces an idle code that is located between two packets.

36. The system of claim 30 wherein said switch-to-new-key code includes an unused ten bit code in an eight bit to ten bit encoding scheme.

37. A system for maintaining synchronization between keys used by an optical line terminal (OLT) to encrypt information within information blocks that are transmitted via a point-to-multipoint optical communications network to a plurality of optical network units (ONUs) and keys used by said plurality of ONUs to decrypt information within information blocks received from said OLT, each information block including a header and a payload, said system comprising:
said OLT; and
said plurality of ONUs;
said OLT including;
an OLT encryption controller for encrypting information within information blocks using ONU-specific keys;
a key synchronization unit for generating a switch-to-new-key code that is not part of said header or said payload of any information blocks that are transmitted from said OLT to said plurality of ONUs and for causing said OLT encryption controller to use new ONU-specific keys to encrypt information within information blocks that are transmitted after said switch-to-new-key code is transmitted to said plurality of ONUs;
each of said plurality of ONUs including:
a key generator for generating a new ONU-specific key that is transmitted to said OLT;
an ONU encryption controller for decrypting information within information blocks using an ONU-specific key;
a key synchronization unit for identifying said switch-to-new-code that is transmitted from said OLT and for causing said ONU encryption controller to use said new ONU-specific key to decrypt information within said information blocks after said switch-to-new-key code is received from said OLT.

38. The system of claim 37 wherein said switch-to-new-key code is transmitted from said OLT to each of said ONUs simultaneously.

39. The system of claim 37 wherein each of said multiple ONUs switches to said ONU-specific keys in response to the same switch-to-new-key code from said OLT.

40. The system of claim 37 wherein said OLT and said ONUs include packet controllers for generating information blocks that are formatted according to the IEEE 802.3 protocol.

41. The system of claim 37 wherein said switch-to-new-key code replaces an idle code that is located between two packets.

42. The system of claim 37 wherein said switch-to-new-key code includes an unused ten bit code in an eight bit to ten bit encoding scheme.
